(19) United States
(12) Patent Application Publication
(10) Pub. No.: US 2021/0229553 A1
(43) Pub. Date: Jul. 29, 2021

(54) DISPLAY CONTROL DEVICE, DISPLAY CONTROL METHOD, AND PROGRAM

(71) Applicant: TOYOTA JIDOSHA KABUSHIKI KAISHA, Aichi-ken (JP)

(72) Inventor: Masashi MORI, Nagoya-shi (JP)

(21) Appl. No.: 17/137,379

(22) Filed: Dec. 30, 2020

(30) Foreign Application Priority Data
Jan. 27, 2020 (JP) 2020-011143

(51) Int. Cl. B60K 35/00; G02B 27/00; G02B 27/01

(52) U.S. Cl. CPC B60K 35/00; G02B 27/0093; G02B 27/0172; B60K 2370/195; B60K 2370/177; G02B 2027/0178; B60K 2370/736; B60K 2370/739; G02B 2027/014; G02B 2027/0141; B60K 2370/1529

(57) ABSTRACT

A display control device is provided including memory, and a processor that is connected to the memory. The processor is configured to acquire display information for display on a display section disposed in front of eyes of an occupant on board a vehicle, gather environmental information relating to an environment of the vehicle, compute a degree of spare capacity, this being a degree of spare mental energy of the occupant to perform operations, based on the gathered environmental information, and perform control so as to prohibit output of the display information to the display section in a cases in which the computed degree of spare capacity is lower than a predetermined value.

### CROSS-REFERENCE TO RELATED APPLICATION

This application is based on and claims priority under 35 USC 119 from Japanese Patent Application No. 2020-011143 filed on Jan. 27, 2020, the disclosure of which is incorporated by reference herein.

### BACKGROUND

### Technical Field

The present disclosure relates to a display control device, a display control method, and a program to control images displayed toward an occupant of a vehicle.

### Related Art

Japanese Patent Application Laid-Open (JP-A) No. 2019-125188 discloses a display control device that displays information on a wearable device, for example a glasses-type wearable device worn by a vehicle occupant. This display control device selects the information to be displayed on the wearable device based on display priority levels.

However, the display control device of JP-A No. 2019-125188 displays unimportant information on the wearable device in cases in which there is no other information with a higher priority level. There is accordingly a possibility of annoying the occupant when the occupant has no spare capacity to perform operations, for example when driving a vehicle.

### SUMMARY

The present disclosure is to provide a display control device, a display control method, and a program capable of suppressing annoyance caused by a display in front of eyes of an occupant in cases in which the occupant has no spare capacity to perform operations.

A display control device according to a first aspect includes: an acquisition section configured to acquire display information for display on a display section disposed in front of eyes of an occupant on board a vehicle; a gathering section configured to gather environmental information relating to an environment of the vehicle; a computation section configured to compute a degree of spare capacity, which is a degree of spare mental energy of the occupant to perform operations, based on the environmental information gathered by the gathering section; and prohibit output of the display information to the display section in a cases in which the degree of spare capacity computed by the computation section is lower than a predetermined value.

In the display control device according to the first aspect, an image is displayed on the display section disposed in front of eyes of the occupant on board the vehicle by outputting the display information to a terminal or the like including the display section. The display control device acquires the display information using the acquisition section, and gathers the environmental information relating to the environment of the vehicle using the gathering section. Note that the environment of the vehicle includes both the environment peripheral to the vehicle and the environment of the vehicle interior.

The computation section of the display control device computes the degree of spare capacity, which is the degree of spare mental energy of the occupant to perform operations, and the control section prohibits output of the display information to the display section in cases in which the degree of spare capacity is lower than the predetermined value. The degree of spare capacity in cases in which the occupant is a driver of the vehicle represents their degree of spare capacity with respect to driving. For example, in cases in which the vehicle is turning right at a crossroad and the driver is paying attention to oncoming vehicles and pedestrians, if their spare capacity with respect to driving drops, there is a lower degree of spare capacity than during normal travel. As another example, in cases in which the occupant is conversing with another occupant, if their spare capacity to perform operations such as setting a destination on a car navigation system drops, there is a lower degree of spare capacity than when sitting doing nothing.

In this display control device, the display information is not displayed by the display section in cases in which the occupant has no spare capacity to perform operations, thus suppressing annoyance felt by the occupant toward a display in front of their eyes.

A display control device according to a second aspect is the display control device of the first aspect, wherein the gathering section is configured to gather peripheral information relating to an environment peripheral to the vehicle as the environmental information, and the computation section is configured to compute the degree of spare capacity with respect to the peripheral environment based on the peripheral information.

In the display control device according to the second aspect, the environment where gathering is performed refers to the environment peripheral to the vehicle. The environment peripheral to the vehicle includes, for example, characteristics of the road on which the vehicle is traveling, the amount of traffic on the road, the familiarity of the occupant with the area, the presence of oncoming vehicles and pedestrians, the distance to the vehicle in front, the vehicle speed, and so on. In this display control device, annoyance felt by the occupant toward a display in front of their eyes is suppressed in cases in which the occupant has no spare capacity to perform operations as a result of the environment peripheral to the vehicle. In particular, presenting an obstacle to driving can be suppressed in cases in which the occupant is the driver.

A display control device according to a third aspect is the display control device of the first aspect or the second aspect, wherein the gathering section is configured to gather vehicle interior information relating to an environment of a vehicle interior as the environmental information, and the computation section is configured to compute the degree of spare capacity with respect to the environment of the vehicle interior based on the vehicle interior information.

In the display control device according to the third aspect, the environment where gathering is performed refers to the environment of the vehicle interior. The environment of the vehicle interior includes, for example, passenger attributes, onboard positions, inter-occupant conversation level, and the temperature, humidity, and odor of the vehicle interior. In this display control device, annoyance felt by the occupant toward a display in front of their eyes is suppressed in cases in which the occupant has no spare capacity to perform operations as a result of the environment of the vehicle interior.

A display control device according to a fourth aspect is the display control device of any one of the first aspect to the third aspect, wherein the computation section is configured to compute a priority level of the display information for display by the display section, and the control section prohibits output of the display information to the display section in cases in which the degree of spare capacity is lower than the predetermined value and the priority level is lower than a set value.

In the display control device according to the fourth aspect, the computation section is capable of computing the priority level in addition to the degree of spare capacity. In this display control device, display of information with a high priority level by the display section is not prohibited, even if the occupant has no spare capacity to perform operations. Failure to report information relating to peace-of-mind or safety to the occupant is thereby suppressed.

A display control device according to a fifth aspect is the display control device of any one of the first aspect to the fourth aspect, further including a recognition section configured to recognize a gaze of another occupant, an identification section configured to identify a target of the gaze recognized by the recognition section, and a generation section configured to generate the display information to report the target identified by the identification section.

In the display control device according to the fifth aspect, the recognition section recognizes the gaze of the other occupant, and the identification section identifies the target in the line of gaze. The control section then displays the display information generated by the generation section on the display section, thus reporting the information regarding the target identified by the identification section to the occupant. This display control device enables information to be shared with the other occupant via the display section.

A display control method according to a sixth aspect includes: an acquisition step of acquiring display information for display on a display section disposed in front of eyes of an occupant on board a vehicle; a gathering step of gathering environmental information relating to an environment of the vehicle; a computation step of computing a degree of spare capacity, which is a degree of spare mental energy of the occupant to perform operations, based on the environmental information gathered at the gathering step; and a control step of performing control so as to prohibit output of the display information to the display section in a cases in which the degree of spare capacity computed at the computation step is lower than a predetermined value.

The display control method according to the sixth aspect is a method in which an image is displayed on the display section disposed in front of eyes of the occupant on board the vehicle by outputting the display information to a terminal or the like including the display section. In this display control method, the display information is acquired at the acquisition step, and the environmental information relating to the environment of the vehicle is gathered at the gathering step. Note that the environment of the vehicle is as previously described. In this display control method, the degree of spare capacity, this being the degree of spare mental energy of the occupant to perform operations, is computed at the computation step, and output of the display information to the display section is prohibited at the control step in cases in which the degree of spare capacity is lower than the predetermined value. The degree of spare capacity is as previously described. In this display control method, the display information is not displayed by the display section in cases in which the occupant has no spare capacity to perform operations, thus suppressing annoyance felt by the occupant toward a display in front of their eyes.

A program according to a seventh aspect causes a computer to execute processing, the processing including: an acquisition step of acquiring display information for display on a display section disposed in front of eyes of an occupant on board a vehicle; a gathering step of gathering environmental information relating to an environment of the vehicle; a computation step of computing a degree of spare capacity, which is a degree of spare mental energy of the occupant to perform operations, based on the environmental information gathered at the gathering step; and a control step of performing control so as to prohibit output of the display information to the display section in a cases in which the degree of spare capacity computed at the computation step is lower than a predetermined value.

The program according to the seventh aspect causes a computer to execute processing such that an image is displayed on the display section disposed in front of eyes of the occupant on board the vehicle by outputting the display information to a terminal or the like including the display section. The computer executing the program acquires the display information at the acquisition step, and gathers the environmental information relating to the environment of the vehicle at the gathering step. Note that the environment of the vehicle is as previously described. The computer also computes the degree of spare capacity, which is the degree of spare mental energy of the occupant to perform operations, at the computation step, and prohibits output of the display information to the display section at the control step in cases in which the degree of spare capacity is lower than the predetermined value. The degree of spare capacity is as previously described. In this program, the display information is not displayed by the display section in cases in which the occupant has no spare capacity to perform operations, thus suppressing annoyance felt by the occupant toward a display in front of their eyes.

The present disclosure is capable of suppressing annoyance caused by a display in front of eyes of an occupant in cases in which the occupant has no spare capacity to perform operations.

### BRIEF DESCRIPTION OF THE DRAWINGS

Exemplary embodiments of the present invention will be described in detail based on the following figures, wherein:

FIG. 1 is a diagram illustrating a schematic configuration of a display control system according to a first exemplary embodiment;

FIG. 2 is a block diagram illustrating hardware configurations of a vehicle and AR glasses of the first exemplary embodiment;

FIG. 3 is a block diagram illustrating an example of functional configuration of a display control device of the first exemplary embodiment;

FIG. 4 is a perspective view illustrating the external appearance of AR glasses of the first exemplary embodiment;

FIG. 5 is a block diagram illustrating an example of configuration of an off-vehicle system of the first exemplary embodiment;

FIG. 6 is a flowchart illustrating a flow of display control processing executed by a display control device of the first exemplary embodiment;

FIG. 7 is a diagram illustrating an example of display during display control processing of the first exemplary embodiment;

FIG. 8 is a block diagram illustrating an example of functional configuration of a display control device of a second exemplary embodiment;

FIG. 9 is a diagram illustrating an example of occupants in a vehicle interior in the second exemplary embodiment; and

FIG. 10 is a diagram illustrating an example of display during display control processing of the second exemplary embodiment.

### DETAILED DESCRIPTION

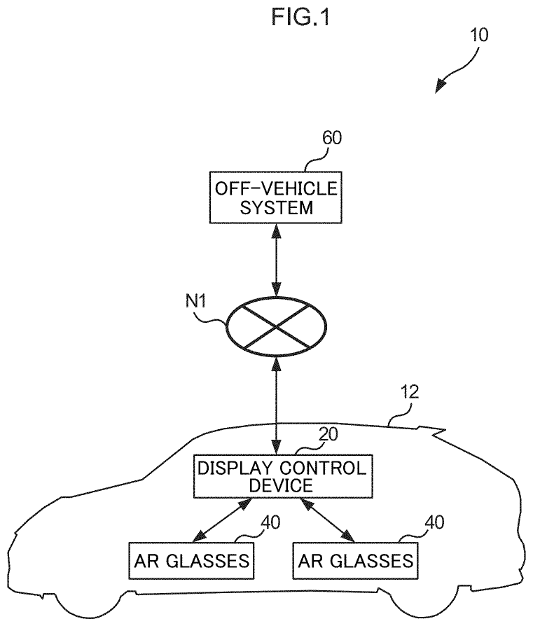

As illustrated in FIG. 1, a display control system 10 according to a first exemplary embodiment is configured including a vehicle 12, a display control device 20, augmented reality (AR) glasses 40, these being a wearable device, and an off-vehicle system 60.

The display control device 20 and the AR glasses 40 of the present exemplary embodiment are installed in the vehicle 12. In the display control system 10, the display control device 20 in the vehicle 12 and the off-vehicle system 60 are connected together through a network N1.

Vehicle

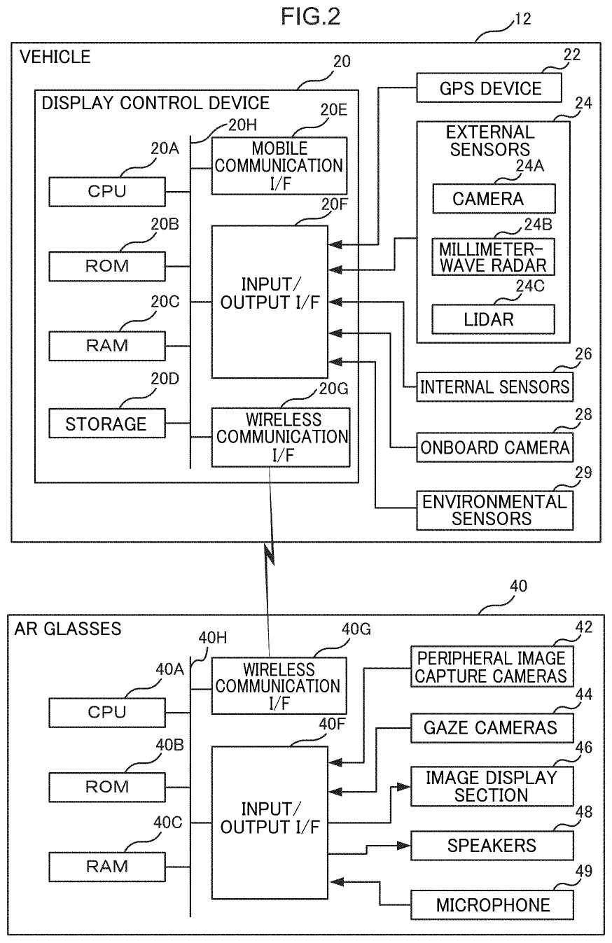

FIG. 2 is a block diagram illustrating hardware configurations of equipment installed in the vehicle 12 and of the AR glasses 40 of the present exemplary embodiment. In addition to the above-mentioned display control device 20, the vehicle 12 also includes a global positioning system (GPS) device 22, external sensors 24, internal sensors 26, an onboard camera 28, and environmental sensors 29.

The display control device 20 is configured including a central processing unit (CPU) 20A, read only memory (ROM) 20B, random access memory (RAM) 20C, storage 20D, a mobile communication interface (I/F) 20E, an input/output IN 20F, and a wireless communication I/F 20G The CPU 20A, the ROM 20B, the RAM 20C, the storage 20D, the mobile communication I/F 20E, the input/output I/F 20F, and the wireless communication I/F 20G are connected together through a bus 20H so as to be capable of communicating with each other. The CPU 20A is an example of a processor, and the RAM 20C is an example of memory.

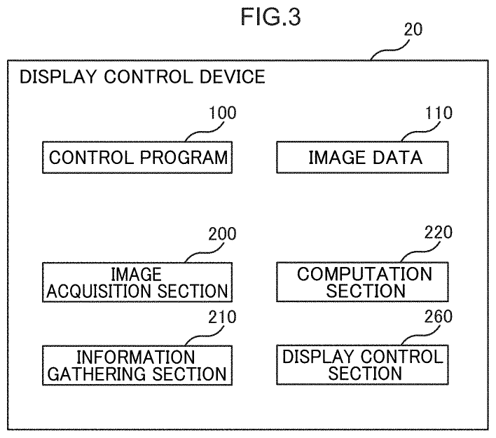

The CPU 20A is a central processing unit that executes various programs and controls various sections. Namely, the CPU 20A reads programs from the ROM 20B and executes these programs using the RAM 20C as a workspace. As illustrated in FIG. 3, in the present exemplary embodiment, a control program 100 is stored in the ROM 20B. The CPU 20A executes the control program 100 to cause the display control device 20 to function as an image acquisition section 200, an information gathering section 210, a computation section 220, and a display control section 260.

As illustrated in FIG. 2, the ROM 20B stores various programs and various data. The RAM 20C serves as a workspace to temporarily store programs and data.

The storage 20D is configured by a hard disk drive (HDD) or a solid state drive (SSD), and stores various programs and various data.

The mobile communication IN 20E is an interface for connecting to the network N1 in order to communicate with the off-vehicle system 60 and the like. A communication protocol such as 5G, LTE, Wi-Fi (registered trademark), dedicated short range communication (DSRC), low power wide area (LPWA), or the like may be applied as this interface.

The input/output I/F 20F is an interface for communicating with the various devices installed in the vehicle 12. The display control device 20 of the present exemplary embodiment is connected to the GPS device 22, the external sensors 24, the internal sensors 26, the onboard camera 28, and the environmental sensors 29 through the input/output I/F 20F. Note that the GPS device 22, the external sensors 24, the internal sensors 26, the onboard camera 28, and the environmental sensors 29 may be directly connected to the bus 20H.

The wireless communication I/F 20G is an interface for connecting with the AR glasses 40. A communication protocol such as Bluetooth (registered trademark) may be applied as this interface.

The GPS device 22 is a device used to measure the current position of the vehicle 12. The GPS device 22 includes a non-illustrated antenna to receive signals from GPS satellites.

The external sensors 24 are a group of sensors that detect peripheral information relating to the environment peripheral to the vehicle 12. The external sensors 24 include a camera 24A configured to capture a predetermined range, a millimeter-wave radar 24B configured to emit seeking waves over a predetermined range and receive reflected waves, and laser imaging detection and ranging (LIDAR) 24C configured to scan a predetermined range. The external sensors 24 may be shared with an autonomous driving device or a driving assist device.

The internal sensors 26 are a group of sensors that detect travel states of the vehicle 12. The internal sensors 26 are configured by a vehicle speed sensor, an acceleration sensor, a yaw rate sensor, and the like.

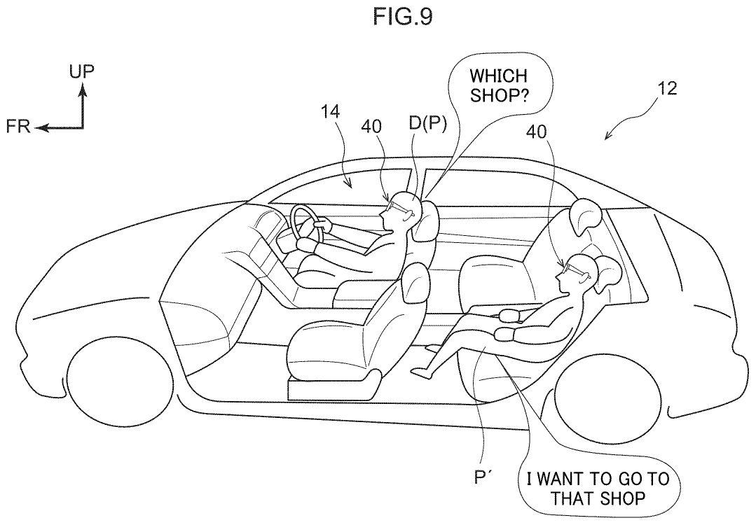

The onboard camera 28 is an image capture device configured to image a vehicle interior 14. The onboard camera 28 is provided at an upper portion of a front windshield or adjacent to an interior mirror, and is capable of imaging the form of an occupant P (see FIG. 9) in the vehicle interior 14. The onboard camera 28 may double as a drive recorder camera. The onboard camera 28 includes an inbuilt microphone, and is capable of picking up audio from the vehicle interior 14 using this microphone.

The environmental sensors 29 are a group of sensors that detect vehicle interior information relating to the environment of the vehicle interior 14. The environmental sensors 29 are configured by a temperature sensor, a humidity sensor, an odor sensor, and the like.

FIG. 3 is a block diagram illustrating an example of functional configuration of the display control device 20. As illustrated in FIG. 3, the display control device 20 includes the control program 100, image data 110, the image acquisition section 200, the information gathering section 210, the computation section 220, and the display control section 260. The control program 100 and the image data 110 are stored in the ROM 20B.

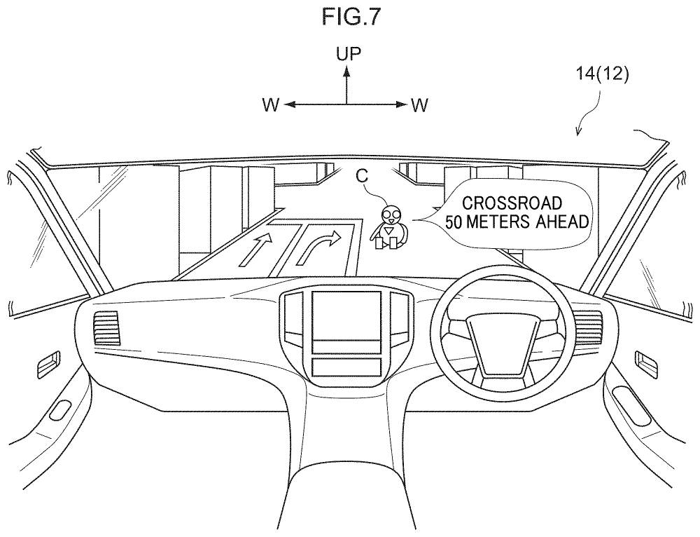

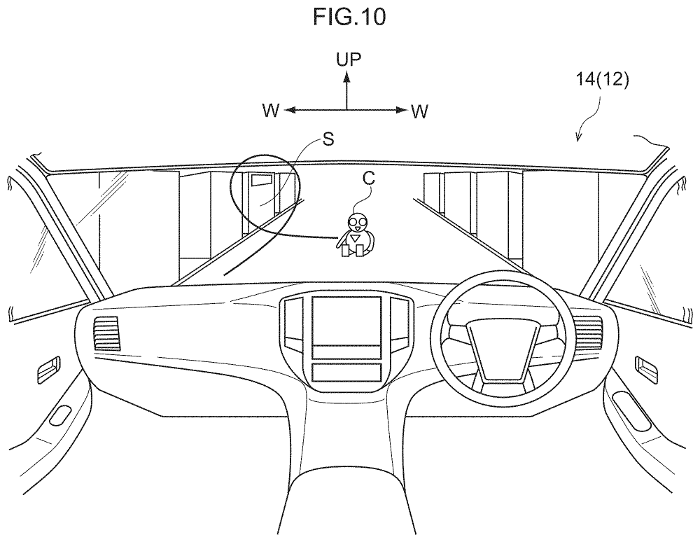

The control program 100 is a program for executing display control processing, described later. The image data 110 is stored data of content for display on the AR glasses 40. For example, the image data 110 includes images of a character C (see FIG. 7 and FIG. 10) displayed as an assistant, an icon representing a shop, images of warning lamps of the vehicle 12, and formulaic text data.

The image acquisition section 200 serves as an acquisition section, and has a function of acquiring display information for display by an image display section 46, described later. The image display section 46 of the present exemplary embodiment is capable of displaying images of the character C, and the display information to be acquired includes image information for the character C. The image information of the character C is stored in the image data 110 of the ROM 20B, and the image acquisition section 200 acquires the image information of the character C from the ROM 20B.

The information gathering section 210 serves as a gathering section, and has a function of gathering environmental information relating to the environment of the vehicle 12. The environment of the vehicle 12 includes both the environment peripheral to the vehicle 12 and the environment of the vehicle interior 14.

The environment peripheral to the vehicle 12 includes, for example, characteristics of the road on which the vehicle 12 is traveling, the amount of traffic on the road, the familiarity of the occupant P with the area, the presence of oncoming vehicles and pedestrians, the distance to the vehicle in front, the time until collision in cases in which a collision with the vehicle in front seems likely, the vehicle speed, and so on. Environmental information relating to the road characteristics and the amount of traffic on the road may, for example, be acquired from an information server 66, described later, of the off-vehicle system 60. Environmental information relating to the familiarity of the occupant P with the area may, for example, be acquired from a personal information database 64, described later, of the off-vehicle system 60. Environmental information relating to the presence of oncoming vehicles and pedestrians and environmental information relating to the relationship with the vehicle in front may, for example, be acquired from the external sensors 24. Environmental information relating to the vehicle speed may, for example, be acquired from the internal sensors 26.

The environment of the vehicle interior 14 includes, for example, passenger attributes, onboard positions, inter-occupant conversation level, and the temperature, humidity, and odor of the vehicle interior 14. Environmental information relating to the passenger attributes and the onboard positions may, for example, be acquired from the onboard camera 28. Environmental information relating to the inter-occupant conversation level may, for example, be acquired from the inbuilt microphone of the onboard camera 28. Environmental information relating to the temperature, humidity, and odor of the vehicle interior 14 may, for example, be acquired from the environmental sensors 29.

The computation section 220 has a function of computing a degree of spare capacity based on the environmental information gathered by the information gathering section 210. The degree of spare capacity refers to the degree of spare mental energy of the occupant P of the vehicle 12 to perform operations. The computation section 220 computes the degree of spare capacity by weighting coefficients for each of the above-described environmental factors. For example, the distance to the vehicle in front is multiplied by a first coefficient, the vehicle speed of the vehicle 12 is multiplied by a second coefficient, the conversation level is multiplied by a third coefficient, and the temperature in the vehicle interior 14 is multiplied by a fourth coefficient, and values obtained by multiplying by the respective coefficients are summed to compute the degree of spare capacity. Note that the method of computing the degree of spare capacity is not limited thereto.

The degree of spare capacity in cases in which the occupant P is a driver D of the vehicle 12 (see FIG. 9) represents their degree of spare capacity with respect to driving. For example, in cases in which the vehicle 12 is turning right at a crossroad and the driver D is paying attention to oncoming vehicles and pedestrians, if their spare capacity with respect to driving drops, there is a lower degree of spare capacity than during normal travel. As another example, in cases in which the occupant P is conversing with another occupant P′, if their spare capacity to perform operations such as setting a destination on a car navigation system drops, there is a lower degree of spare capacity than when sitting doing nothing.

The computation section 220 also computes priority levels of the display information for display on the image display section 46. These priority levels include plural levels such as a “peace-of-mind/safety level” and a “comfort level” for each content item, and display information imparted with the peace-of-mind/safety level is prioritized over display information imparted with the comfort level for display on the image display section 46. Note that in cases in which plural content items are available for display on the image display section 46, the computation section 220 may set the priority levels by comparing the relative levels of each of the plural display information items.

The display control section 260 serves as a control section, and has a function of outputting display information for display on the image display section 46. The display control section 260 outputs display information in cases in which the degree of spare capacity computed by the computation section 220 is a predetermined value or greater, and in cases in which the priority level computed by the computation section 220 is a set value or greater. In cases in which the degree of spare capacity computed by the computation section 220 is lower than the predetermined value, and in cases in which the priority level computed by the computation section 220 is lower than the set value, the display control section 260 prohibits output of the display information.

Note that the predetermined value that serves as a threshold value for the degree of spare capacity may be set to a desired value. Moreover, a different predetermined value may be set for each occupant P. Moreover, the setting values that serve as threshold values for the priority level may be set to any level value.

As illustrated in FIG. 2, the AR glasses 40 are configured including a CPU 40A, ROM 40B, RAM 40C, an input/output I/F 40F, and a wireless communication I/F 40G The CPU 40A, the ROM 40B, the RAM 40C, the input/output I/F 40F, and the wireless communication I/F 40G are connected together through a bus 40H so as to be capable of communicating with each other. Functionality of the CPU 40A, the ROM 40B, the RAM 40C, the input/output I/F 40F, and the wireless communication I/F 40G is similar to the functionality of the CPU 20A, the ROM 20B, the RAM 20C, the input/output I/F 20F, and the wireless communication I/F 20G of the display control device 20 described above.

The AR glasses 40 further include peripheral image capture cameras 42, gaze cameras 44, the image display section 46, speakers 48, and a microphone 49.

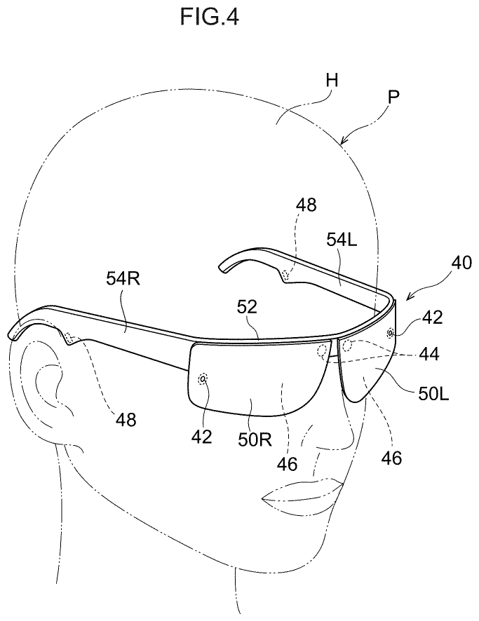

As illustrated in FIG. 4, the AR glasses 40 are worn on the head H of the occupant P. In the AR glasses 40, base portions of left and right temples 54L, 54R are attached to a frame 52, and left and right lenses 50L, 50R that allow light to pass through are also attached to the frame 52. The image display section 46 that is capable of displaying images is respectively provided at inner side faces of the lenses 50L, 50R (the faces facing toward eyes of the occupant P wearing the AR glasses 40).

The image display section 46 serves as a display section, and has a see-through configuration such that light incident to the lenses 50L, 50R from outer side faces of the lenses 50L, 50R passes through the image display section 46 so as to be incident to eyes of the occupant P wearing the AR glasses 40. Thus, when an image is displayed on the image display section 46, the occupant P wearing the AR glasses 40 sees the image (virtual image) displayed on the image display section 46 overlaid on their actual field of vision through the lenses 50L, 50R (for example the real-world scene ahead of the vehicle 12).

A pair of the peripheral image capture cameras 42 that image ahead of the AR glasses 40 are attached to the outer side faces of the lenses 50L, 50R at positions that do not obstruct the field of view of the occupant P wearing the AR glasses 40. A pair of the gaze cameras 44 that capture eyes of the occupant P wearing the AR glasses 40 in order to detect the gaze of the occupant P are attached to the inner side faces of the lenses 50L, 50R at positions that do not obstruct the field of view of the occupant P wearing the AR glasses 40.

A pair of the speakers 48 are provided to the temples 54L, 54R at positions that correspond to the ears of the occupant P when the AR glasses 40 are being worn by the occupant P.

In the present exemplary embodiment, the CPU 40A displays images on the image display section 46 and transmits images captured by the peripheral image capture cameras 42 and gaze detection results of the gaze cameras 44 to the display control device 20 in response to instructions from the display control device 20. The CPU 40A also outputs sound through the speakers 48 as required.

The CPU 40A, the ROM 40B, the RAM 40C, the input/output I/F 40F, the wireless communication I/F 40G, and the microphone 49 are, for example, inbuilt to the frame 52. Moreover, for example, a battery (not illustrated in the drawings) is inbuilt to the temples 54L, 54R, and a power supply jack (not illustrated in the drawings) is provided to the temples 54L, 54R. The AR glasses 40 are an example of a wearable device, and the image display section 46 is an example of a display section.

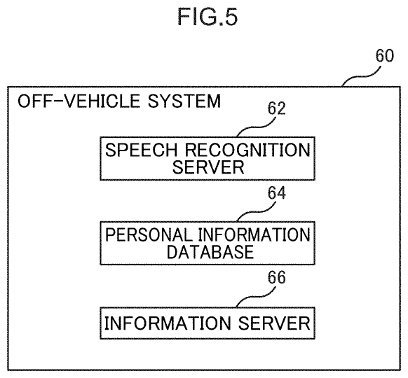

FIG. 5 illustrates an example of configuration of the off-vehicle system 60. The off-vehicle system 60 includes at least a speech recognition server 62, the personal information database 64, and the information server 66. In the present exemplary embodiment, the speech recognition server 62, a server storing the personal information database 64, and the information server 66 are provided separately. However, there is no limitation thereto, and configuration may be made using a single server.

The speech recognition server 62 has a function of recognizing speech uttered by the occupant P of the vehicle 12.

The personal information database 64 stores personal information about the occupant P of the vehicle 12. For example, the personal information database 64 includes address information regarding the occupant P who is the driver D, thus enabling the familiarity of the driver D with the area to be provided to the display control device 20 as environmental information. As another example, the personal information database 64 includes information such as the age and gender of the occupant P, thus enabling attributes of the occupant P to be provided as environmental information.

The information server 66 is a server that holds traffic information, road information, and the like gathered from a vehicle information and communication system (VICS) (registered trademark) center. The information server 66 is capable of providing congestion information as environmental information.

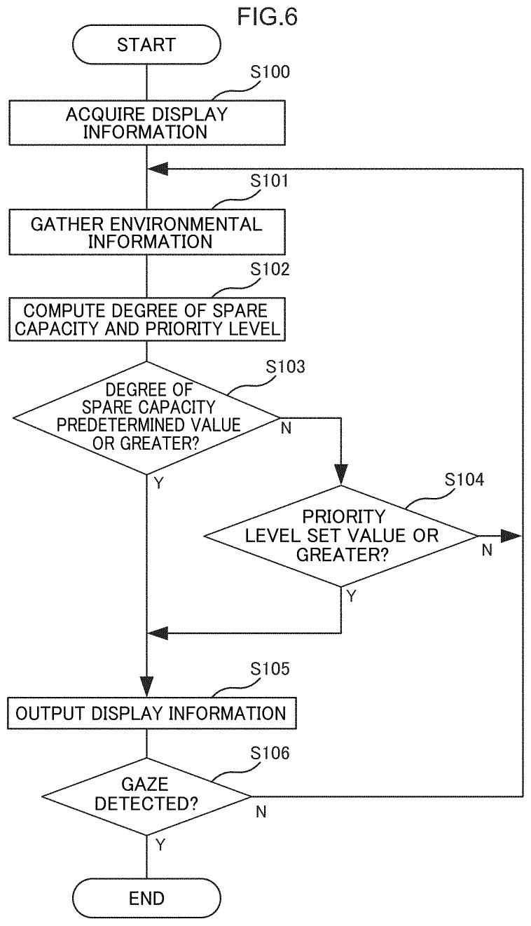

Next, explanation follows regarding an example of display control processing executed by the display control device 20 of the present exemplary embodiment, with reference to the flowchart of FIG. 6.

At step S100 in FIG. 6, the CPU 20A acquires the display information. For example, the CPU 20A acquires an image of the character C illustrated in FIG. 7 from the image data 110.

At step S101, the CPU 20A gathers the environmental information. Namely, the CPU 20A gathers both the environmental information relating to the environment peripheral to the vehicle 12 and the environmental information relating to the environment of the vehicle interior 14.

At step S102, the CPU 20A computes the degree of spare capacity and the priority level.

At step S103, the CPU 20A determines whether or not the degree of spare capacity is the predetermined value or greater. In cases in which the CPU 20A determines that the degree of spare capacity is the predetermined value or greater, processing proceeds to step S105. In cases in which the CPU 20A determines that the degree of spare capacity is not the predetermined value or greater, namely is less than the predetermined value, processing proceeds to step S104.

At step S104, the CPU 20A determines whether or not the priority level is the set value or greater. In cases in which the CPU 20A determines that the priority level is the set value or greater, processing proceeds to step S105. On the other hand, in cases in which the CPU 20A determines that the priority level is not the set value or greater, namely is less than the set value, processing returns to step S101.

At step S105, the CPU 20A outputs the display information to the AR glasses 40. Accordingly, as illustrated in FIG. 7, an image of the character C of the display information is displayed on the AR glasses 40 by the image display section 46. A video image displayed on the image display section 46 may be displayed so as to appear three-dimensional by applying left and right eye parallax, and may be disposed at a desired position in space. Note that as well as displaying the image of the character C, audio may be output from the speakers 48 to suggest that the character C is talking.

At step S106, the CPU 20A determines whether or not the gaze of the occupant P has been detected. More specifically, the CPU 20A determines whether or not the gaze of the occupant P is directed toward the displayed image of the character C. In cases in which the gaze of the occupant P has been detected, the CPU 20A ends the display control processing. On the other hand, in cases in which the gaze of the occupant P has not been detected, the CPU 20A returns to step S101. Namely, the image of the character C only continues to be displayed on the image display section 46 in cases in which the degree of spare capacity is the predetermined value or greater, and in cases in which the priority level is the set value or greater.

The display control device 20 of the present exemplary embodiment outputs display information and audio information to the AR glasses 40 that include the image display section 46 disposed in front of eyes of the occupant P on board the vehicle 12 so as to display the image on the image display section 46 and output the audio from the speakers 48. Accordingly, as illustrated in FIG. 7 as an example, the driver D can be presented with the character C saying “crossroad 50 meters ahead” when the vehicle 12 is approaching a crossroad.

Note that in cases in which a video image of a character is displayed above an instrument panel by a hologram projection device using holographic technology, the display is small in size, and the display position is limited. Accordingly, the content display size is limited if the conditions of being visible during driving and the projection device being installed at a position that does not get in the way of peripheral components are to be met.

In the case of a hologram, a video image displayed to appear three-dimensional may not be clearly visible to the occupant P. In particular, in cases in which sunlight is reflected and in cases in which the distance is far from the occupant P, such a hologram becomes difficult to see. Moreover, in cases in which the projection device is provided at a position easily seen by all occupants P, when sensitive information is displayed its contents are revealed to the other occupant P′. Moreover, if speakers output to the entire vehicle interior 14, the functionality cannot be used in situations in which sound and video images are undesirable, for example when a child is asleep.

By contrast, in the present exemplary embodiment, the AR glasses 40 and the display control device 20 are coordinated with each other, enabling for example the character C to be expressed as an agent that moves freely around the field of view of the occupant P, without being constrained by the onboard space. Moreover, the video images in the AR glasses 40 are not easily seen by the other occupant P′, thus enabling the display of sensitive information.

The display control device 20 acquires the display information using the image acquisition section 200, and gathers the environmental information relating to the environment of the vehicle 12 using the information gathering section 210. The computation section 220 computes the degree of spare capacity, this being the spare mental energy of the occupant P to perform operations, and the display control section 260 prohibits output of the display information to the image display section 46 in cases in which the degree of spare capacity is lower than the predetermined value. In the present exemplary embodiment, the display information is not displayed by the image display section 46 in cases in which the occupant P has no spare capacity to perform operations, thus suppressing annoyance felt by the occupant P toward a display in front of their eyes.

Note that in cases in which the peripheral information relating to the environment peripheral to the vehicle 12 has been gathered as the environmental information, annoyance felt by the occupant P toward a display in front of their eyes is suppressed in cases in which the occupant P has no spare capacity to perform operations as a result of the environment peripheral to the vehicle 12. In particular, presenting an obstacle to driving can be suppressed in cases in which the occupant P is the driver D.

In cases in which the vehicle interior information relating to the environment of the vehicle interior 14 has been gathered as the environmental information, annoyance felt by the occupant P toward display in front of their eyes is suppressed in cases in which the occupant P has no spare capacity to perform operations due the environment of the vehicle interior 14.

Moreover, in the present exemplary embodiment, the computation section 220 is capable of computing the priority level in addition to the degree of spare capacity. In the present exemplary embodiment, the display of information with a high priority level by the image display section 46 is not prohibited, even if the occupant P has no spare capacity to perform operations. Failure to report information relating to peace-of-mind or safety to the occupant P is thereby suppressed.

A second exemplary embodiment enables display of the character C during conversation with another occupant P′. Explanation follows regarding points that differ from the first exemplary embodiment. Note that configurations matching those of the first exemplary embodiment are allocated the same reference numerals, and detailed explanation thereof is omitted.

In the present exemplary embodiment, plural occupants P, specifically the driver D and the other occupant P′, are on board the vehicle 12, and each of the occupants P is wearing a pair of the AR glasses 40 (see FIG. 9).

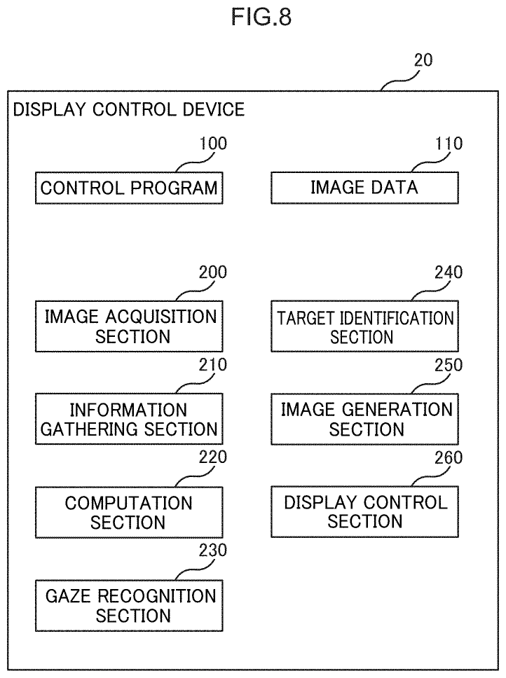

FIG. 8 is a block diagram illustrating an example of functional configuration of a display control device 20 of the present exemplary embodiment. As illustrated in FIG. 8, the display control device 20 includes the control program 100, the image data 110, the image acquisition section 200, the information gathering section 210, the computation section 220, a gaze recognition section 230, a target identification section 240, an image generation section 250, and the display control section 260. The image acquisition section 200, the information gathering section 210, the computation section 220, the gaze recognition section 230, the target identification section 240, the image generation section 250, and the display control section 260 are implemented by the CPU 20A reading and executing the control program 100 stored in the ROM 20B.

The gaze recognition section 230 serves as a recognition section and has a function of recognizing the gaze of the occupant P wearing the AR glasses 40. The gaze recognition section 230 acquires gaze information of the occupant P from the gaze cameras 44 in order to recognize a position of the gaze.

The target identification section 240 serves as an identification section, and has a function of identifying a target of the gaze recognized by the gaze recognition section 230. The target identification section 240 acquires a captured image depicting the field of vision of the occupant P wearing the AR glasses 40 from the peripheral image capture cameras 42. The target identification section 240 then superimposes the gaze position recognized by the gaze recognition section 230 on the acquired captured image in order to identify an object present at the gaze position in the captured image as a target present in the line of gaze.

The image generation section 250 serves as a generation section, and has a function of generating display information to report the target identified by the target identification section 240. For example, the image generation section 250 generates display information for the image display section 46 in the form of a circular frame surrounding the target identified by the target identification section 240.

In the present exemplary embodiment, the display information is displayed on the image display section 46 during conversation between the other occupant P′ and the driver D. For example as illustrated in FIG. 9, the other occupant P′ sifting in a rear seat in the vehicle interior 14 might say “I want to go to that shop” to the driver D. At this stage, the driver D does not know which shop on the road the vehicle 12 is traveling along the other occupant P′ is talking about from the conversation with the other occupant P′ alone. Accordingly, the driver D may ask “Which shop?”. Namely, the driver D is unable to identify the direction of the gaze of the other occupant P′ in the rear seat through the conversation with the other occupant P′. It can also be difficult to have a shared appreciation of the target in the outside world if the conversation is difficult to hear.

To address this, in the present exemplary embodiment, the gaze recognition section 230 recognizes the gaze of the other occupant P′, and the target identification section 240 identifies the target in the line of gaze. The display control section 260 then displays the display information generated by the image generation section 250 on the image display section 46, thus reporting the information regarding the target identified by the target identification section 240 to the occupant. More specifically, as illustrated in FIG. 10, the image display section 46 of the AR glasses 40 worn by the driver D displays a video image of the character C floating so as to circle around a shop S referred to by the other occupant P′ in the rear seat saying “that shop”. This enables the shop S that the other occupant P′ in the rear seat is talking about to be indicated using the AR glasses 40. Moreover, outputting audio from the other occupant P′ in the rear seat and the character C through the speakers 48 enables conversation in the vehicle cabin to flow smoothly.

The exemplary embodiment described above enables information to be shared with the other occupant P′ via the image display section 46. Note that display control processing based on the degree of spare capacity and the priority level may also be executed in the present exemplary embodiment. Namely, in cases in which the driver D has no spare capacity with respect to driving, the floating video image of the character C is not displayed.

Note that position information of the shop S indicated by the character C may be stored by the display control device 20 of the present exemplary embodiment working together with the car navigation system. So doing enables the shop S indicated during the conversation between the driver D and the other occupant P′ to be stored as a location of interest on a map, even if the shop indicated is not visited on this occasion. The location of interest may similarly be stored on a map even when the shop S is not indicated in cases in which the degree of spare capacity is less than the predetermined value and the priority level is less than the set value. This enables a visit to be made to the stored shop S at a later date or when time has become available.

Note that the various processing executed by the CPU 20A reading and executing software (a program) in the above exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The various types of processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

In the above exemplary embodiments, the program is in a format pre-stored (installed) in a computer-readable non-transitory recording medium. For example, the control program 100 of the display control device 20 of the vehicle 12 is pre-stored in the ROM 20B. However, there is no limitation thereto, and the respective programs may be provided in a format recorded on a non-transitory recording medium such as compact disc read only memory (CD-ROM), digital versatile disc read only memory (DVD-ROM), or universal serial bus (USB) memory. Alternatively, the program may be provided in a format downloadable from an external device through a network.

The processing flows explained in the above exemplary embodiments are merely examples, and superfluous steps may be omitted, new steps may be added, or the processing sequences may be changed within a range not departing from the spirit of the present disclosure.

What is claimed is:

1. A display control device comprising:
a memory, and
a processor that is coupled to the memory, the processor being configured to:
acquire display information for display on a display section disposed in front of eyes of an occupant on board a vehicle,
gather environmental information relating to an environment of the vehicle,
compute a degree of spare capacity, which is a degree of spare mental energy of the occupant to perform operations, based on the gathered environmental information, and
prohibit output of the display information to the display section in a case in which the computed degree of spare capacity is lower than a predetermined value.

2. The display control device of claim 1, wherein the processor is further configured to:
gather peripheral information relating to an environment peripheral to the vehicle as the environmental information; and
compute the degree of spare capacity with respect to the peripheral environment based on the peripheral information.

3. The display control device of claim 1, wherein the processor is further configured to:
gather vehicle interior information relating to an environment of a vehicle interior as the environmental information; and
compute the degree of spare capacity with respect to the environment of the vehicle interior based on the vehicle interior information.

4. The display control device of claim 1, wherein the processor is further configured to:
compute a priority level of the display information for display by the display section; and
prohibit output of the display information to the display section in a case in which the degree of spare capacity is lower than the predetermined value and the priority level is lower than a set value.

5. The display control device of claim 1, wherein the processor is further configured to:
recognize a gaze of another occupant;
identify a target of the gaze; and
generate the display information to report the identified target.

6. A display control method comprising:
an acquisition step of acquiring display information for display on a display section disposed in front of eyes of an occupant on board a vehicle;
a gathering step of gathering environmental information relating to an environment of the vehicle;
a computation step of computing a degree of spare capacity, which is a degree of spare mental energy of the occupant to perform operations, based on the environmental information gathered at the gathering step; and
a control step of performing control so as to prohibit output of the display information to the display section in a case in which the degree of spare capacity computed at the computation step is lower than a predetermined value.

7. A program executable by a computer to perform processing, the processing comprising:
an acquisition step of acquiring display information for display on a display section disposed in front of eyes of an occupant on board a vehicle;
a gathering step of gathering environmental information relating to an environment of the vehicle;
a computation step of computing a degree of spare capacity, which is a degree of spare mental energy of the occupant to perform operations, based on the environmental information gathered at the gathering step; and
a control step of performing control so as to prohibit output of the display information to the display section in a case in which the degree of spare capacity computed at the computation step is lower than a predetermined value.
